(19) United States
(12) Patent Application Publication
(10) Pub. No.: US 2007/0291629 A1
(43) Pub. Date: Dec. 20, 2007

(54) Optical recording medium

(75) Inventors: Toshiyuki Ogano, Osaka (JP); Toshinori Sugiyama, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/812,209

(22) Filed: Jun. 15, 2007

(30) Foreign Application Priority Data
Jun. 15, 2006 (JP) 2006-165848

(51) Int. Cl. G11B 7/24

(52) U.S. Cl. 369/275.4

(57) ABSTRACT

The optical recording medium is provided with a substrate having optical transparency and disc shape; and a recording layer formed on the substrate in which incident light enters from the substrate side to record/read information. The substrate includes a distribution of the amount of birefringence in a recording area of the substrate to cancel out the birefringence derived from a stress generated by rotating the substrate; a push-pull signal obtained by an optical spot at a wavelength of 405 nm being 0.2 or more, when the substrate rotates at a constant linear velocity and the number of revolutions 6,000 rpm; and a ratio of the maximum value to the minimum value (maximum value/minimum value) in the push-pull signal being 2.0 or less.

### BACKGROUND OF THE INVENTION

1. Field of the Invention

The present invention relates to an optical recording medium, in more detail, to an optical recording medium allowing stable recording and reading in high speed rotating.

2. Description of the Related Art

At present, in addition to the continuing expansion of the amount of information for a computer, information of music, a still image and a dynamic image advances to digitization, resulting in a dramatic increase in the amount of information in these applications. For example, DVD (Digital Versatile Disc) is manufactured from a disc-shaped molded substrate 0.6 mm thick, on which a surface with an information signal is copied and a substrate with a similar thickness without the signal surface while keeping the signal surface inside. A two-sided recording product of DVD-RAM (Digital Versatile Disc Random Access Memory) is manufactured from two disc-shaped molded substrates, each having a thickness of 0.6 mm, on which a surface with the information signal is copied and the substrates are adhered so as to keep the surface with the information signal inside.

Additionally, a recent increase in optical disc capacity has made a change in an optics system from a red laser to a blue laser and a Blu-ray Disc (BD) is commercialized to record an image with a quality of a HDTV (High Definition Television) level for digital broadcast. Such BD is manufactured by copying a surface with the information signal to a substrate 1.1 mm thick and placing a cover layer 0.1 mm thick on the surface with the information signal. A recording capacity of the double-layered structure BD reaches 50 GB.

A different standard from BD also includes development of HD DVD, which is presently discussed in the DVD Forum. This is based on the optical recording medium using a blue laser as a light source and consisting of a single disc on an incident light side of recording and reading light with thickness of 0.6 mm similar to DVD (that is, HD DVD). A light source wavelength (λ) and a numerical aperture (NA) of a condenser objective lens in HD DVD are 405 nm and 0.65, respectively, while in DVD the light source wavelength λ is 650 nm and NA is 0.6, shifting the light source wavelength to a shorter wavelength relative to DVD and increasing NA to thus achieve a higher capacity disc than DVD.

A cheap polycarbonate resin is generally used as the substrate of such an optical recording medium, but known to cause birefringence.

On the other hand, an optical information write/read device, which records the information on the optical recording medium and then reads the recorded information generally uses a polarization optics system with a combination of a polarized-light splitting element and a ¼ wavelength plate in order to improve the efficiency of light usage. As birefringence occurs at a protective layer of the optical recording medium when using such a polarization optics system, the amount of the light received by a light detector receiving the reflected light from the optical recording medium is decreased to result in a decrease of a signal-to-noise ratio (S/N ratio) in reading. Birefringence generated lowers a peak intensity of a focused spot formed on the optical recording medium, thereby leading to an increase of the optical power required for recording. Such a phenomenon becomes particularly obvious in the optics system using the blue laser.

To address the problems involved with generation of birefringence of the optical recording medium, such technologies are reported, for example, a method to use an optical head device provided with an element varying the polarization direction between the condenser objective lens and the ¼ wavelength plate (see Japanese Patent Application Laid-Open Publication No. H10-83552), a method to use an optical pickup device provided with the wavelength plate which gives an optical path difference corrected with a desired optical path difference corresponding to the amount of birefringence derived from optical anisotropy of the optical recording medium between two polarization components, as an actual optical path difference (see Japanese Patent Application Laid-Open Application No. 2004-245957) and the like.

On the other hand, with the increase of the optical disc capacity a transfer rate speeds up and the number of revolutions of the optical disc presently reaches up to 10,000 rpm. In such high-speed rotating it is known that birefringence derived from a principal stress in the radial direction of the disc ((σᵣ) and a principal stress in the circumferential direction (σₜ) is generated in a disc-shaped optical disc substrate. When the birefringence generated by high-speed rotating of the substrate is added to the birefringence inherent to the resin material constituting the substrate described above, retardation as optical distortion of the substrate is increased (hereinafter optionally referred to as “Re increment (ΔRe)”). Accordingly, tracking could lead to deviate when recoding and reading the signal on the optical recording medium.

“Retardation” herein is an optical phase difference in the substrate and an index to detect and quantify a magnitude of the birefringence.

The amount of birefringence (R₀) directly related to the retardation can be represented by the following formula (1) using the principal stress in the radial direction of the disc (σᵣ) and the principal stress in the circumferential direction (σₜ) as described above. In formula (1), C is a photoelastic coefficient of the material forming the substrate and t is a thickness of the substrate. Further, in the following formula (1), R₀ is assigned as the amount of negative birefringence when the principal stress in the radial direction (σᵣ) is larger than the principal stress in the circumferential direction (σₜ) (σᵣ>σₜ).

(formula 1)

R₀=C(σᵣ−σₜ)t (1)

When the substrate with an inner radius r₁ and an outer radius r₂ such as a disc-shaped substrate with a center hole such as DVD, HD DVD and the like (hereinafter optionally referred to as “hollow centered disc”) rotates within a drive, a chucking area is fixed with a drive to rotate the disc in a state where stress is not applied to an inner wall and an outer wall. At this time, the principal stress in the radial direction (σᵣ) and the principal stress in the circumferential direction (σₜ) in any radius (r) of such a rotating substrate are given by the following formulas (2) and (3), respectively. In formulas (2) and (3), γ, ν and ω are a specific gravity of the material, a Poisson's ratio and an angular speed (rad/sec), respectively.

$$\begin{matrix}( formula 2 ) & \\ {σ}_{r} = \frac{γ {r}_{2}^{2} {ω}^{2}}{g} \cdot \frac{3 + v}{8} \{ 1 + {( \frac{{r}_{1}}{{r}_{2}} )}^{2} - {( \frac{r}{{r}_{2}} )}^{2} - {( \frac{{r}_{1}}{r} )}^{2} \} & ( 2 ) \\ ( formula 3 ) & \\ {σ}_{t} = \frac{γ {r}_{2}^{2} {ω}^{2}}{g} \cdot \frac{3 + v}{8} \{ 1 + {( \frac{{r}_{1}}{{r}_{2}} )}^{2} - \frac{1 + 3 v}{3 + v} {( \frac{r}{{r}_{2}} )}^{2} - {( \frac{{r}_{1}}{r} )}^{2} \} & ( 3 )\end{matrix}$$

Specifically, for example, when a drive equipped with an optics system having a laser beam of wavelength (λ) at 405 nm and the condenser objective lens with the numerical number (NA) of 0.65 operates at a rotation speed of 1× (linear velocity, 6.61 m/s) and a rotating system uses CLV (Constant Linear Velocity), the number of revolutions of a hollow centered disc-shaped polycarbonate resin substrate (thickness (t), 0.6 mm) (r₁=15 mm and r₂=120 mm) reaches 2,800 rpm in the inner circumference and 1,000 rpm in the outer circumference, respectively.

FIG. 6 is a graph to show a relation of a stress generated in the revolving hollow centered disc with the Re increment (ΔRe) in CLV (linear velocity, 6.61 m/s). As shown in FIG. 6, when the rotation speed is a 1× speed, little stress by rotating the substrate is generated on the inner circumference area of the substrate and the Re increment (ΔRe) (unit, nm: D-pass) derived from the amount of birefringence (R₀) obtained by calculation (results by simulation) is also very small. Accordingly, only a value inherent to the substrate is required for consideration as the amount of birefringence (R₀) and a risk to deviate the tracking is very small when recording and reading the signal on the optical recording medium. In calculation of the principal stress in the radial direction (σᵣ) (unit, kgf/cm²), the principal stress in the circumferential direction (σₜ) (unit, kgf/cm²) and the amount of birefringence (R₀), the following values for physical properties of the polycarbonate resin are used.
γ: 0.0012 kg/cm³
ν: 0.3
C: 0.0000071 cm²/kgf

Correspondingly, when a rotation speed of such drive is a 4× speed (linear velocity, 26.44 m/s) and the rotation system is CLV, the number of revolutions of an identical hollow centered disc-shaped polycarbonate resin substrate (thickness (t), 0.6 mm) reaches 10,000 rpm in the inner circumference and 4,400 rpm in the outer circumference, increasing the stress inside the substrate due to the rotating of substrate.

FIG. 7 is a graph to show a relation of a stress generated in the revolving hollow centered disc with the Re increment (ΔRe) in CLV (linear velocity, 26.44 m/s). As shown in FIG. 7, when the rotation speed is a 4× speed, a large stress by rotating the substrate is particularly generated in an inner circumference area of the substrate, so that it is anticipated that the Re increment (ΔRe) (unit, nm: D-pass) is 40 nm or more in the inner circumference area of the substrate (as simulated results) derived from the amount of birefringence (R₀) obtained by calculation as compared with the above case with a 1× speed (linear velocity, 6.61 m/s).

Thus, there is concern that in the optical disc substrate at high-speed rotating, an increase in the principal stress in the radial direction (σᵣ) and the principal stress in the circumferential direction (σₜ) in the substrate generates the birefringence to increase retardation as the optical distortion, thereby decreasing a push-pull signal and posing a risk to deviate the tracking when recoding and reading the signal on the optical recording medium.

The present invention is performed to address such problems in the optical recording medium at high-speed rotating.

That is, an object of the present invention is to provide the optical recoding medium capable of stable recording and reading using the optics system with the blue laser at high-speed rotating.

### SUMMARY OF THE INVENTION

The present inventors have earnestly studied to address the above problems and found that the optical recoding medium using the substrate with a given distribution of the birefringence can prevent the amount of push-pull signal from decreasing. Thus, the present invention has been completed based on such findings.

The above object of the present invention can be obtained by an optical recording medium comprising: a substrate having optical transparency and disc shape; and a recording layer formed on the substrate in which incident light enters from the substrate side to record/read information. The substrate includes: a distribution of the amount of birefringence in a recording area of the substrate to cancel out the birefringence derived from a stress generated by rotating the substrate; a push-pull signal obtained by an optical spot at a wavelength of 405 nm being 0.2 or more, when the substrate rotates at a constant linear velocity and the number of revolutions 6,000 rpm; and a ratio of the maximum value to the minimum value (maximum value/minimum value) in the push-pull signal being 2.0 or less.

It is preferable that a guide groove formed on the surface of the substrate of the optical recording medium to which the present invention is applied has a groove depth (Dp) of 25 nm to 35 nm and a track pitch (Tp) of 200 nm to 250 nm.

Furthermore, it is preferable that above the substrate there is a phase-change recording layer on which information is recorded by the light transmitting the substrate.

The above object of the present invention can be obtained by an optical recording medium comprising: a substrate having optical transparency; and a phase-change recording layer, in which incident light enters from the substrate side to record/read information. The substrate includes a portion with a polarity of the amount of birefringence in the substrate to be negative in a recording area of the substrate.

In the optical recording medium to which the present invention is applied, it is preferable that the amount of birefringence (Rᵢ) in any radius (rᵢ) in the substrate is −30 nm≦Rᵢ≦10 nm.

Then, the optical recording medium to which the present invention is applied is characterized that, when the substrate rotates at a constant linear velocity and the number of revolutions of 6000 rpm, a push-pull signal obtained by an optical pickup equipped with a light source of a wavelength at 405 nm and a condenser objective lens with a numerical aperture (NA) of 0.65 is 0.2 or more and a ratio of the maximum value to the minimum value (maximum value/minimum value) of the push-pull signal is 2.0 or less.

Furthermore, the above object of the invention can be achieved by an optical recording medium comprising: a substrate having optical transparency; and a phase-change recording layer formed on the substrate in which incident light of a wavelength at 405 nm enters from the substrate side to record/read information; and a dummy substrate laminated at least via a reflective layer to the phase-change recording layer. Both a push-pull signal obtained when rotating the substrate at a constant linear velocity of a 1× speed and a push-pull signal obtained when rotating the substrate at a constant linear velocity of a 4× speed are 0.2 or more, and a ratio of the maximum value to the minimum value (maximum value/minimum value) of the push-pull signal is 2.0 or less.

The optical recording medium of the present invention allows stable recording and reading in a high-speed rotating using the optics system equipped with the blue laser.

### BRIEF DESCRIPTION OF THE DRAWINGS

FIG. 1 is a diagram to describe optical recording medium, to which the present exemplary embodiment is applied;

FIG. 2 is a diagram showing a cross-section of optical recording medium;

FIG. 3 is a diagram showing wobble groove (Gᵥ) of optical recording medium;

FIG. 4 is a schematic diagram showing the four-division photo-detector;

FIG. 5 is a diagram to show a distribution of the amount of birefringence in the radial direction in the substrate of the optical recording medium used in Example;

FIG. 6 is a graph to show a relation of a stress generated in the rotating hollow centered disc with the Re increment (ΔRe) in CLV (linear velocity, 6.61 m/s); and

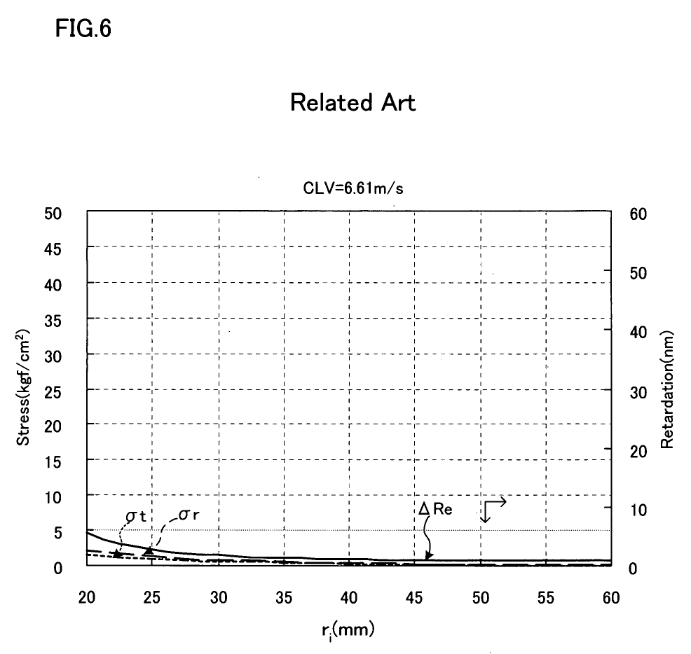

FIG. 7 is a graph to show a relation of a stress generated in the rotating hollow center disc with the Re increment (ΔRe) in CLV (linear velocity, 26.44 m/s).

### DETAILED DESCRIPTION OF THE PREFERRED EMBODIMENTS

A best mode (exemplary embodiment) for carrying out the present invention is described below based on the drawings. The present invention is not limited to the exemplary embodiment below, but may be modified in various forms within the gist of the invention. Further, the drawings used are used for description of the present exemplary embodiment, but not intended to represent an actual size.

First, a structure of the optical recording medium, to which the present exemplary embodiment is applied, is described.

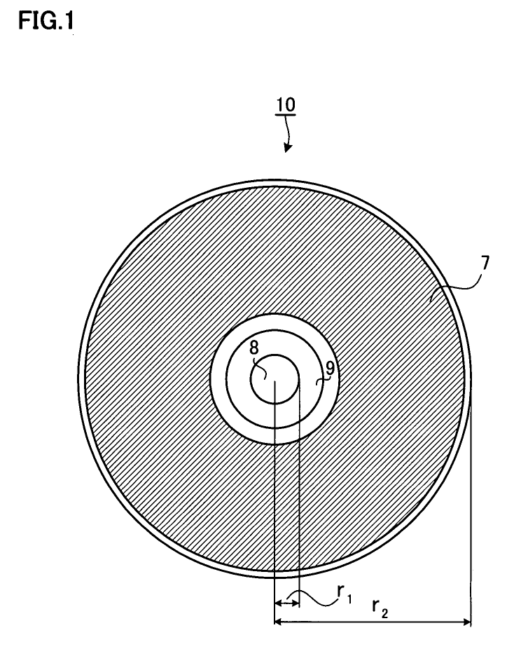

FIG. 1 is a diagram to describe an optical recording medium 10, to which the present exemplary embodiment is applied. As shown in FIG. 1, the optical recording medium 10 has a disc shape with outer radius r₂ having a center hole 8 with inner radius r₁ at center and has chucking area 9 to fix the optical recording medium 10 to a drive (not shown) when mounting to the given drive, and a recording area 7 placed outside a chucking area 9.

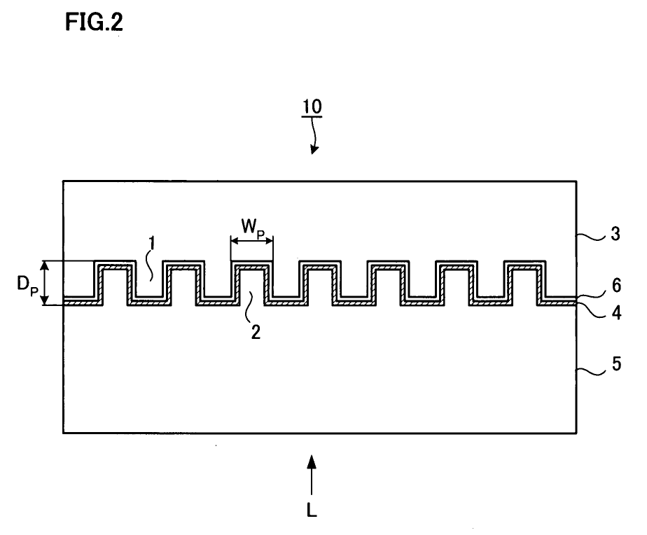

Next, FIG. 2 is a diagram showing a cross-section of optical recording medium 10. HD DVD-RW disc is exemplified to describe herein. As shown in FIG. 2, the optical recording medium 10 has a substrate 5 made of a optically transparent material, to which recording and reading light L enters, and successively on the substrate 5 a phase-change recording layer 4 made of a phase-change recording material, a reflective layer 6 made of a reflective material and further a dummy substrate 3 placed on the reflective layer 6. Recording and reading light L enters from a side of the substrate 5 to irradiate the phase-change recording layer 4.

A surface of the substrate 5 has a guide groove constituting groove 2 with a given groove width (groove width, Wₚ) and a groove depth (Dₚ), and land 1 placed between two adjacent grooves of the groove 2. The groove 2 forms a wobble groove to meander a surface of the substrate 5.

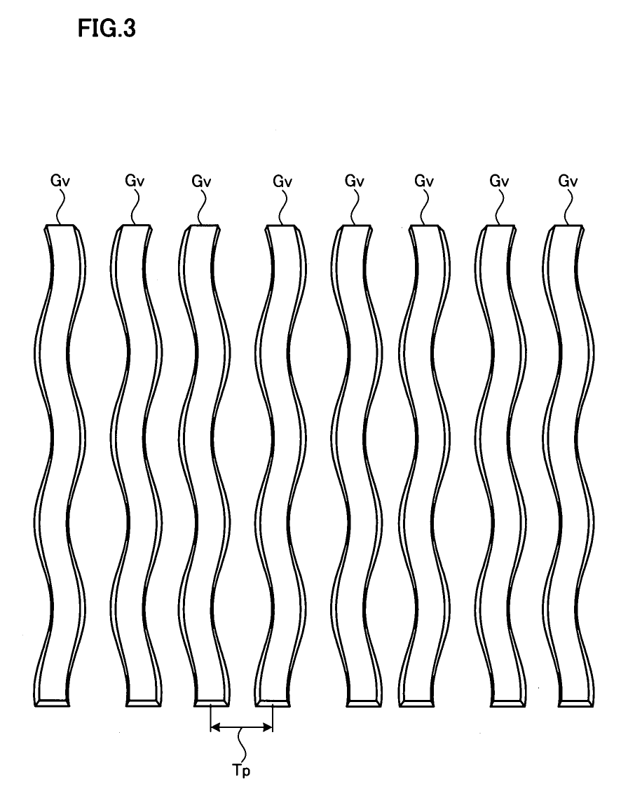

FIG. 3 herein is a diagram showing wobble groove (Gᵥ) of the optical recording medium 10. That is, as shown in FIG. 3, an HD DVD-RW disc, which is a rewritable medium of HD DVD uses a format for address administration based on wobble groove (Gᵥ) in which the groove is meanderingly formed on the substrate 5. Wobble groove (Gᵥ) herein is formed along a recording track with a given interval of track pitch (Tₚ) mainly for tracking servo.

Groove depth (Dₚ) of the guide groove formed on the surface of the substrate 5 is preferably from 25 nm to 35 nm. Track pitch (Tₚ) of wobble groove (Gᵥ) is preferably from 200 nm to 250 nm.

In the present exemplary embodiment, the substrate 5 is prepared by injection molding, in which the groove 2 with groove width (Wₚ) of 240 nm and groove depth (Dₚ) of 30 nm is formed at a track pitch (Tₚ) interval of 400 nm on a surface of the polycarbonate resin (Panlite AD-5503 manufactured by Teijin Chemicals Ltd.) disc with a center hole inner diameter of 15 mm, an outer diameter of 120 mm and a thickness of 0.6 mm. Information for disc recognition, address information and the like are pre-recorded by above wobble groove (Gᵥ, FIG. 3) on the substrate 5.

In such a disc to record the signal within wobble groove (Gᵥ), tracking is generally performed using the push-pull signal. The push-pull signal herein is a signal generated by an arithmetic operation of each output signal from a four-division photo-detector used in a pickup of the recording and reading device.

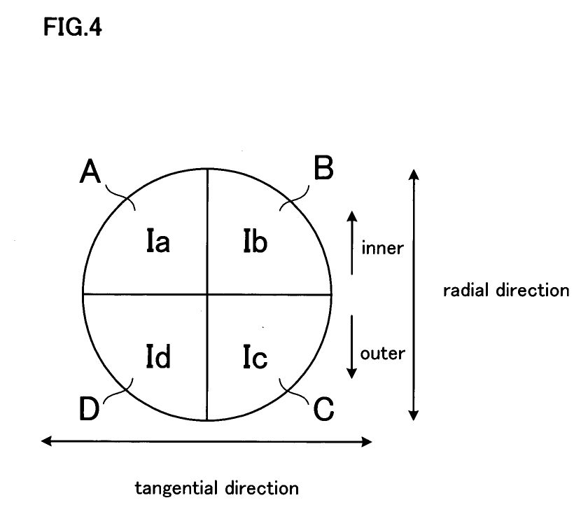

FIG. 4 is a schematic diagram showing the four-division photo-detector. As shown in FIG. 4, the four-division photo-detector has four photo-detectors (A, B, C and D), each of which has a read output of Ia, Ib, Ic and Id, respectively. This time, push-pull signal (T) is defined as a ratio (that is, T=|(Ia+Ib)−(Ic+Id)|/|(Ia+Ib+Ic+Id)|) of the difference of measured signal value subjected to AC coupling between inner circumference and outer circumference (that is |(Ia+Ib)−(Ic+Id)|) to the sum of measured signal value subjected to DC coupling (that is, |(Ia+Ib+Ic+Id)|).

The amount of push-pull signal is known to vary with the influence of a pattern transfer in molding of the substrate 5, a making process for the phase-change recording layer 4, the amount of birefringence in the substrate 5, and the like.

Materials constituting each layer are described next.

A material for the substrate 5 is not particularly limited to, but include, in addition of the above polycarbonate resin, for example, resins such as acrylic resins, methacrylic resins, amorphous polyolefin resins, polyester resins, polystyrene resins, epoxy resins and the like, glass, and others.

The phase-change recording layer 4 is composed of a phase-change recording material. A thickness of the phase-change recording layer 4 is generally from 10 nm to 15 nm. Specific examples of the phase-change recording material include, for example, materials such as Sb—Te, Ge—Te, Ge—Sb—Te, In—Sb—Te, Ag—In—Sb—Te, MA-Ge—Sb—Te (MA is at least one of the elements from Au, Cu, Pd, Ta, W, Ir, Sc, Y, Ti, Zr, V, Nb, Cr, Mo, Mn, Fe, Ru, Co, Rh, Ni, Ag, Tl, S, Se and Pt), Sn—Sb—Te, In—Se—Tl, In—Se—Tl-MB (MB is at least one of the elements from Au, Cu, Pd, Ta, W, Ir, Sc, Y, Ti, Zr, V, Nb, Cr, Mo, Mn, Fe, Ru, Co, Rh, Ni, Ag, Ti, S, Se and Pt), Sn—Sb—Se, Bi—Ge—Te and the like.

The reflective layer 6 is composed of a reflective material such as a metal, an alloy or the like. A thickness of the reflective layer 6 is generally around 100 nm. As the reflective material, a metal, for example, Au, Al, Ag, Cu, Ti, Cr, Ni, Pt, Ta, Cr and Pd can be used singly or as an alloy. Moreover, in addition to these metals as a major component, it may contain a metal and a metalloid such as Mg, Se, Hf, V, Nb, Ru, W, Mn, Re, Fe, Co, Rh, Ir, Cu, Zn, Cd, Ga, In, Si, Ge, Te, Pb, Po, Sn, Bi and the like.

The dummy substrate 3 is not required to have optical transparency like the substrate 5 and may use, for example, plastics, metal, glass and the like with appropriate processability and rigidity. The dummy substrate 3 is formed in a disc shape with an inner diameter of 15 mm, an outer diameter of 120 mm and a thickness of 0.6 mm similarly to the substrate 5.

The optical recording medium 10, to which the present exemplary embodiment is applied, may have other layers as needed. For example, between the substrate 5 and the phase-change recording layer 4 or between the phase-change recording layer 4 and the reflective layer 6 may be formed, for example, a protective layer composed of a ZnS—SiO₂ mixture, SiNₓ and the like, respectively. A UV protective layer composed of a UV curable resin may be also placed between the reflective layer 6 and the dummy substrate 3. Moreover, an interface layer, a heat diffusion layer and the like may be placed.

The substrate 5 for the optical recording medium 10, to which the present exemplary embodiment is applied is next detailed further.

In the present exemplary embodiment, the disc-shaped substrate 5 is characterized with a distribution of the amount of birefringence in the radial direction of the substrate 5 to cancel out the birefringence derived from the stress (principal stress in the radial direction (σᵣ) and the principal stress in the circumferential direction (σₜ)) generated in rotating and with reduction of an increase of retardation as an optical distortion, for example, even in high speed rotating with the number of revolutions at 6,000 rpm or more.

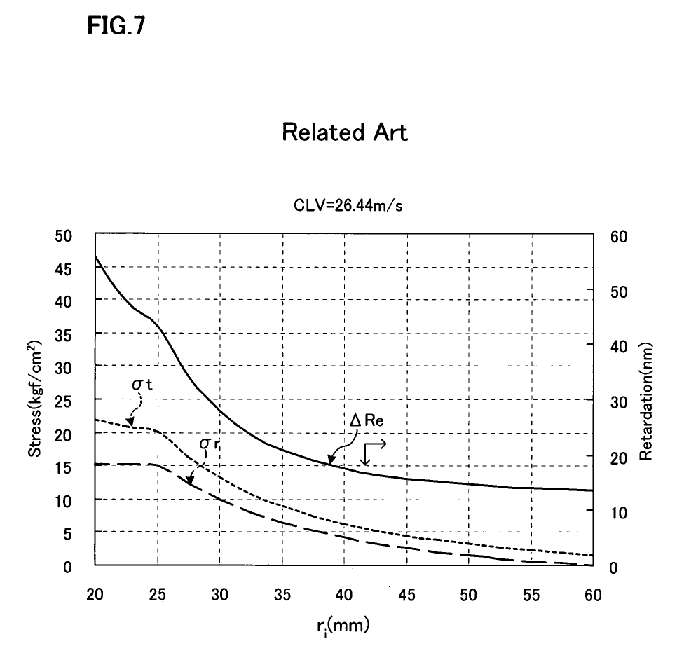

In case of the hollow centered disc which rotates at a high speed, for instance, at a linear velocity of 26.44 m/s (CLV) (number of revolutions, 6,000 rpm or more) as shown in FIG. 7, the amount of birefringence (Ri) of substrate 5 in any radius (ri) of the recording area 7 should have a distribution to cancel out the amount of birefringence (R0) (Re increment (ΔRe)) derived from a high speed rotating at each radius (ri) location. Specifically, the amount of birefringence (Ri) of substrate 5 in any radius (ri) of recording area 7 is preferably −30 nm≦Ri≦10 nm.

When an absolute value of the amount of birefringence (Rᵢ) is excessively large or excessively small, a sufficient push-pull signal is difficult to obtain, when a drive uses the optics system equipped with the light source of wavelength λ at 405 nm and the condenser objective lens with the numerical aperture NA of 0.65 and the optical recording medium 10 rotates at a constant linear velocity and the number of revolutions at 6000 rpm or more.

A method to form a distribution of the amount of birefringence (Rᵢ) in the radial direction of the substrate 5 to cancel out the birefringence derived from a stress generated in rotating the substrate 5 is not particularly limited. Specifically, for example, when the substrate 5 is formed by injection molding of an appropriate optically transparent resin, a distribution of the amount of birefringence (Rᵢ) in the substrate 5 can be obtained by a proper combination of factors such as molecular orientation by resin flow, hydrostatic distortion by fill compression, heat stress by solidification cooling, relaxation phenomenon thereof and the like.

The optical recording medium 10, to which the present exemplary embodiment is applied has a distribution of the amount of birefringence (Rᵢ) in the radial direction of disc-shaped substrate 5 to cancel out the birefringence derived from a stress (σᵣ and σₜ) generated in rotating. When the substrate 5 rotates at the constant linear velocity and the number of revolutions at 6,000 rpm and an optical spot formed by the optical pickup with the light source of a wavelength (λ) of 405 nm and a condenser objective lens with the numerical aperture (NA) of 0.65 is used to read the information, a value of the push-pull signal (Pₚ) across the substrate 5 is 0.2 or more and a ratio (Pₚₘₐₓ/Pₚₘᵢₙ) of the maximum value (Pₚₘₐₓ) to the minimum value (Pₚₘᵢₙ) in the above push-pull signal is 2.0 or less. As a result, tracking does not deviate in high-speed rotating, and the recording and reading are performed stably.

### EXAMPLE

The present exemplary embodiment is further detailed below according to examples. However, the present exemplary embodiment is not limited by examples.

### Preparation of Optical Recording Medium

Using a given injection compression molding machine (SD40E manufactured by Sumitomo Heavy Industries, Ltd.), a 0.6 mm thick polycarbonate resin substrate (inner radius r₁=15 mm and outer radius r₂=120 mm) having a guide groove of a groove depth of 30 nm and a groove width of 240 nm is molded. The molding condition involves an initial mold opening of 0.6 mm, a maximum injection fill speed of 150 mm/s, a resin temperature of 380° C. and a mold temperature of 115° C. for a fixed die and 110° C. for movable die, respectively. Clamping is controlled in multistage and its initial clamping force is 300 MPa.

A phase-change recording layer composed of a Bi—Ge—Te alloy and a reflective layer composed of a Ag—Nd—Cu alloy each are next deposited in turn by sputtering on the surface of this substrate, to which a dummy substrate (inner radius r₁=15 mm and outer radius r₂=120 mm) with a thickness of 0.6 mm is laminated to prepare the optical recording medium.

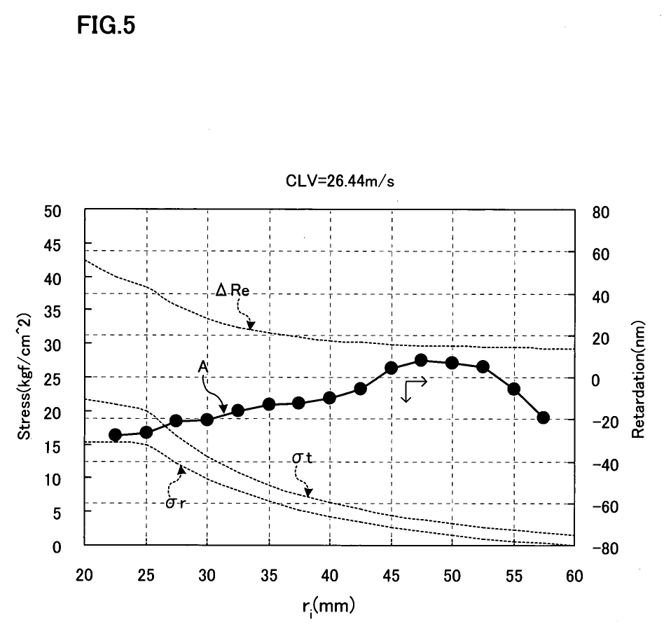

FIG. 5 is a diagram to show a distribution of the amount of birefringence in the radial direction in the substrate of the optical recording medium thus prepared. As shown in FIG. 5, the substrate prepared by the above method has a distribution of the amount of birefringence in the radial direction of the substrate, in which polarity of the amount of birefringence (retardation) becomes negative in an area of radius from 22 mm to 44 mm and a radius from 54 mm to 57 mm (in FIG. 5, filled circle and solid line A).

In FIG. 5, the main stress in the radial direction (σᵣ) and the main stress in the circumferential direction (σₜ) when rotating the hollow centered disc with the thickness of 0.6 mm, the inner diameter r1 of 15 mm and the outer diameter r2 of 120 mm at a high speed of the linear velocity at 26.44 m/s (CLV) (shown as dotted line) as well as the Re increment (ΔRe) (unit nm: D-pass) derived from the amount of birefringence (R0) obtained by calculation (results by simulation, given by dotted line) are simultaneously shown.

### Information Recording and Reading Device

An evaluation device equipped with an optical pickup with a laser beam of wavelength (λ) at 405 nm and the condenser objective lens with the numerical aperture (NA) of 0.65 is used.

### Example

The amount of the push-pull signal (hereinafter, amount of PP signal (Pₚ)) at a given radial location (rᵢ) in the radial direction of the substrate is measured using the above information recording and reading device, when the optical recording medium prepared by the above method rotates at a high speed of a 1× speed (linear velocity, 6.61 m/s) (CLV) and a 4× speed (linear velocity, 26.44 m/s) (CLV) (number of revolutions, 6,000 rpm or more). The results are shown in Table 1.

TABLE 1

rᵢ (mm)

| | 25.0 | 30.0 | 35.0 | 40.0 |
|---|---|---|---|---|
| 1 × P_{P} | 0.378 | 0.337 | 0.339 | 0.327 |
| 4 × P_{P} | 0.249 | 0.240 | 0.245 | 0.276 |

rᵢ (mm)

| | 45.0 | 50.0 | 55.0 | 58.0 |
|---|---|---|---|---|
| 1 × P_{P} | 0.307 | 0.297 | 0.286 | 0.283 |
| 4 × P_{P} | 0.249 | 0.241 | 0.253 | 0.259 |

The results given in Table 1 indicate that the amount of the PP signal (Pₚ) in the optical recording medium has a distribution of the amount of birefringence as shown in FIG. 5 (in FIG. 5, filled circle and solid line A) and the maximum value (Pₚₘₐₓ) of the amount of the PP signal (Pₚ) within a radial area r from 25.0 mm to 58.0 mm becomes (Pₚₘₐₓ) 0.276 in high speed rotating at a 4× speed (linear velocity, 26.44 m/s) (CLV) (number of revolutions, 6,000 rpm or more) by canceling out the birefringence derived from the stress generated by the rotating.

Further, the minimum value (Pₚₘᵢₙ) of the amount of the PP signal (Pₚ) within a radial area r from 25.0 mm to 58.0 mm becomes 0.240.

Moreover, Pₚₘₐₓ/Pₚₘᵢₙ is 0.276/0.240, thus giving 1.15, indicating that a relation of Pₚₘₐₓ/Pₚₘᵢₙ≦2.0 is satisfied.

Such a disc has a sufficient margin in a value of an acceptable inner circumference variation for the amount of the push-pull signal with roughly a +100/−50% tolerance.

The optical recording medium used in the present example allows stable tracking by the above evaluation device as well as stable recording and reading from the inner circumference to the outer circumference.

Furthermore, at a 1× speed, the maximum value (Pₚₘₐₓ) of the amount of the PP signal (Pₚ) is 0.378 in an area of a radius r from 25.0 mm to 58.0 mm.

Further, the minimum value (Pₚₘᵢₙ) of the amount of the PP signal (Pₚ) is 0.283 in an area of a radius r from 25.0 mm to 58.0 mm.

Moreover, Pₚₘₐₓ/Pₚₘᵢₙ is 0.378/0.283, thus giving 1.34, indicating that a relation of Pₚₘₐₓ/Pₚₘᵢₙ≦2.0 is satisfied. Such a disc has a sufficient margin in a value of an acceptable inner circumference variation for the amount of the push-pull signal (Pₚ) with roughly a +100/−50% tolerance even in a low speed rotating.

As described above, the optical recording medium according to the present exemplary embodiment allows stable recording and reading at high speed rotating even if a blue semiconductor laser is used as the optics system.

The invention may be embodied in other specific forms without departing from the spirit or essential characteristics thereof. The present embodies are therefore to be considered in all respects as illustrative and not restrictive, the scope of the invention being indicated by the appended claims rather than by the forgoing description and all changes which come within the meaning and range of equivalency of the claims are therefore intended to be embraced therein.

The entire disclosure of Japanese Patent application No. 2006-165848 filed on Jun. 15, 2006 including the specification, claim, drawings and summary is incorporated herein by reference in its entity.

What is claimed is:

1. An optical recording medium comprising:
a substrate having optical transparency and disc shape; and
a recording layer formed on the substrate in which incident light enters from the substrate side to record/read information,
the substrate including:
a distribution of the amount of birefringence in a recording area of the substrate to cancel out the birefringence derived from a stress generated by rotating the substrate;
a push-pull signal obtained by an optical spot at a wavelength of 405 nm being 0.2 or more when the substrate rotates at a constant linear velocity and the number of revolutions 6,000 rpm; and
a ratio of the maximum value to the minimum value (maximum value/minimum value) in the push-pull signal being 2.0 or less.

2. The optical recording medium according to claim 1, wherein the substrate includes the distribution of the amount of birefringence in a radial direction of the substrate and the amount of birefringence (Rᵢ) in any radius (rᵢ) of the recording area in the substrate is −30 nm≦Rᵢ≦10 nm.

3. The optical recording medium according to claim 1, wherein the optical spot is formed by an optical pickup equipped with a light source at a wavelength of 405 nm and a condenser objective lens with a numerical aperture (NA) of 0.65.

4. The optical recording medium according to claim 1, wherein a surface of the substrate is provided with a guide groove having a groove depth of 25 nm to 35 nm and a track pitch of 200 nm to 250 nm.

5. The optical recording medium according to claim 1, wherein the recording layer formed on the substrate is a phase-change recording layer containing a phase-change recording material.

6. An optical recording medium comprising:
a substrate having optical transparency; and
a phase-change recording layer in which incident light enters from the substrate side to record/read information,
wherein the substrate includes a portion with a polarity of the amount of birefringence in the substrate to be negative in a recording area of the substrate.

7. The optical recording medium according to claim 6, wherein the amount of birefringence (Rᵢ) in any radius (rᵢ) of the recording area in the substrate is −30 nm≦Rᵢ≦10 nm.

8. The optical recording medium according to claim 6, wherein the polarity of the amount of birefringence in the substrate is negative at least in an innermost circumference and an outermost circumference in the recording area of the substrate.

9. The optical recording medium according to claim 6, wherein, when the substrate rotates at a constant linear velocity and the number of revolutions of 6000 rpm, a push-pull signal obtained by an optical pickup equipped with a light source of a wavelength at 405 nm and a condenser objective lens with a numerical aperture (NA) of 0.65 is 0.2 or more and a ratio of the maximum value to the minimum value (maximum value/minimum value) of the push-pull signal is 2.0 or less.

10. The optical recording medium comprising:
a substrate having optical transparency;
a phase-change recording layer formed on the substrate in which incident light of a wavelength at 405 nm enters from the substrate side to record/read information; and
a dummy substrate laminated at least via a reflective layer to the phase-change recording layer,
wherein both a push-pull signal obtained when rotating the substrate at a constant linear velocity of a 1× speed and a push-pull signal obtained when rotating the substrate at a constant linear velocity of a 4× speed are 0.2 or more, and
a ratio of the maximum value to the minimum value (maximum value/minimum value) of the push-pull signal is 2.0 or less.

11. The optical recording medium according to claim 10, wherein the amount of birefringence (Rᵢ) in any radius (rᵢ) of a recording area in the substrate is −30 nm≦Rᵢ≦10 nm.

12. The optical recording medium according to claim 10, wherein the push-pull signal is obtained by an optical spot formed by an optical pickup equipped with a light source of the wavelength at 405 nm and a condenser objective lens with a numerical aperture (NA) of 0.65.

13. The optical recording medium according to claim 10, wherein the 1× speed is a linear velocity of 6.61 m/s and the 4× speed is 26.44 m/s.
